(19) United States
(12) Patent Application Publication
(10) Pub. No.: US 2024/0171089 A1
(43) Pub. Date: May 23, 2024

(54) ULTRA-DENSE MODULAR MULTILEVEL POWER CONVERTER

(71) Applicant: PORTLAND STATE UNIVERSITY, Portland, OR (US)

(72) Inventor: Mahima Gupta, Portland, OR (US)

(21) Appl. No.: 18/553,123

(22) PCT Filed: Mar. 28, 2022
(86) PCT No.: PCT/US2022/071390

§ 371 Date: Sep. 28, 2023

Related U.S. Application Data
(60) Provisional application No. 63/168,792, filed on Mar. 31, 2021.

(51) Int. Cl. H02M 7/483; H02M 1/00; H02M 1/12

(52) U.S. Cl. CPC H02M 7/4835; H02M 1/0054; H02M 1/126

(57) ABSTRACT

Various embodiments of an ultra-dense modular multilevel power converter are provided. In one example, a power converter includes a capacitor, and a circuit comprising a first switch and a second switch, wherein a switch throw of the first switch is coupled to a first terminal of the capacitor and a switch throw of the second switch is coupled to a second terminal of the capacitor, wherein a pole voltage is fully differential between a first pole of the first switch and a second pole of the second switch, and wherein the first pole and the second pole are isolated from the capacitor when the circuit is in a zero state. In this way, several such modules may be connected in series to form multilevel power converters with reduced capacitance requirements for coupling high-voltage sources.

### CROSS REFERENCE TO RELATED APPLICATIONS

This application claims priority to U.S. Provisional Application No. 63/168,792, entitled “ULTRA-DENSE MODULAR MULTILEVEL POWER CONVERTER,” and filed Mar. 31, 2021, the entire contents of which is hereby incorporated by reference for all purposes.

### FIELD

The disclosure relates to power converters in general, and to modular multilevel power converters in particular.

### BACKGROUND

Power electronic converters enable power transfer from energy sources to energy loads by reconciling their differences in voltages, currents, and frequency of operation while facilitating conversion between direct current (DC) and alternating current (AC) as well as DC-DC and AC-AC conversion. Power electronic converters are thus useful for various applications such as renewable energy integration, long distance high-voltage electric power transmission, electrified transportation systems, industrial motor drives, energy storage systems, and so on. Such converters generally include semiconductor switches, such as metal-oxide-semiconductor field-effect transistors (MOSFETs), insulated gate bipolar transistors (IGBTs), and thyristors, as well as energy storage elements, such as capacitors and inductors. The switches operate at a switching frequency and connect their associated nodes to different voltage and/or current levels. The energy storage devices act as smoothening elements for the switched voltages and/or currents to meet the source and load performance specifications.

### SUMMARY

Embodiments are disclosed for ultra-dense modular multilevel power converters. In one example, a power converter includes a capacitor and a circuit including a first switch and a second switch, wherein a switch throw of the first switch is coupled to a first terminal of the capacitor and a switch throw of the second switch is coupled to a second terminal of the capacitor. In some aspects, a pole voltage is fully differential between a first pole of the first switch and a second pole of the second switch, and the first pole and the second pole are isolated from the capacitor when the circuit is in a zero state. In this way, several such modules may be connected in series to form multilevel power converters with reduced capacitance requirements for coupling high-voltage sources.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 is a schematic diagram illustrating an example half-bridge module for a minimal capacitor multilevel converter, according to an embodiment;

FIG. 2 is a schematic diagram illustrating an example full-bridge module for a minimal capacitor multilevel converter, according to an embodiment;

FIG. 3 is a schematic diagram illustrating an example half-bridge module for a minimal capacitor multilevel converter implemented with MOSFETs, according to an embodiment;

FIG. 4 is a schematic diagram illustrating a first example full-bridge module for a minimal capacitor multilevel converter implemented with MOSFETs, according to an embodiment;

FIG. 5 is a schematic diagram illustrating a second example full-bridge module for a minimal capacitor multilevel converter implemented with MOSFETs, according to an embodiment;

FIG. 6 is a schematic diagram illustrating a third example full-bridge module for a minimal capacitor multilevel converter implemented with MOSFETs, according to an embodiment;

FIG. 7 is a schematic diagram illustrating an example three-phase half-bridge module in a minimal capacitor multilevel converter, according to an embodiment;

FIG. 8 is a schematic diagram illustrating an example DC-AC minimal capacitor multilevel converter comprising half-bridge modules, according to an embodiment;

FIG. 9 is a schematic diagram illustrating an example AC-AC cascaded minimal capacitor multilevel converter comprising half-bridge modules, according to an embodiment;

FIG. 10 is a schematic diagram illustrating an example AC-AC direct minimal capacitor multilevel converter comprising full-bridge modules, according to an embodiment;

FIG. 11 is a schematic diagram illustrating an example AC-AC direct reduced minimal capacitor multilevel converter comprising half-bridge modules configured as a single arm, according to an embodiment;

FIG. 12 is a schematic diagram illustrating an example distributed DC-AC minimal capacitor multilevel converter comprising half-bridge modules, according to an embodiment; and

FIG. 13 is a schematic diagram illustrating another example distributed DC-AC minimal capacitor multilevel converter comprising half-bridge modules, according to an embodiment.

### DETAILED DESCRIPTION

The following description relates to various embodiments of power converters. In particular, various embodiments of an ultra-dense modular multilevel power converter are provided.

In order to realize power converters that go beyond the ratings of the forming elements, the traditional approach is to connect them in series and/or in parallel. An example application of such power converters is high-voltage (HV) DC transmission systems which interconnect two AC systems and require high-voltage high-power DC-AC power conversion. In particular, the Pacific DC Intertie has a line capacity of 3.1 GW and transmits electricity from near The Dalles, Oregon to the Los Angeles area in California. One such implementation of HV systems includes thyristors-based current source converters (CSC). In this converter, the gate-controlled thyristor devices are connected in series to meet the high voltage requirements. These converters have been the workhorse of high-voltage DC transmission since their inception in the 1950s. With the advances in controlled semiconductor switches such as IGBTs and MOSFETs in the 1970s, voltage source converters (VSC), the dual of CSCs, have emerged as a viable option. While these two converters have been the primary candidates for high voltage power conversion, innovation in circuit topologies have paved the way for modular, high performance and fault tolerant designs.

Among the several multilevel topologies, active neutral-point clamped converters and flying capacitor converters have gained prominence. However, they face various challenges beyond three-level power conversion such as increased complexity, challenging voltage balancing algorithms, and commutation issues (due to parasitic pathways leading to over-voltages during switching action). Further, commutation issues make them relatively incompatible with advanced and upcoming wide band-gap semiconductor switches which are considered to be the primary drivers of next-generation power dense and efficient converters. Thus, these topologies have limited applicability in medium to high voltage power applications. Modular multilevel converters (MMLC) and the recently introduced modular multi-stage converters (MMSC) enjoy their dominance in power electronic conversion at high voltage and power levels due to their modularity, better performance, and fault tolerance. Built by interconnecting smaller power converter modules in unique ways, they may be the only practical options in many next-generation applications. However, the MMLC topology is accompanied by its high energy storage requirements leading to voluminous capacitor requirements with limited lifetime and reliability.

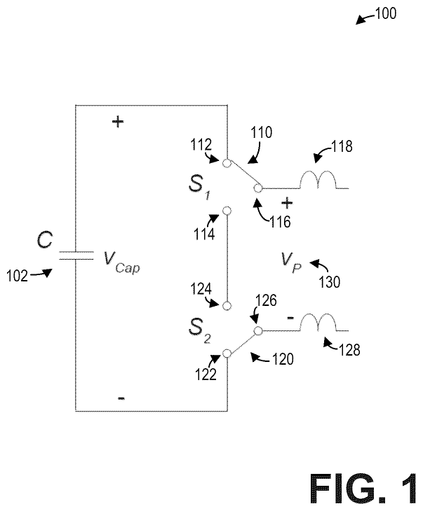

In the DC-AC MMLC topology, each of the DC and AC phases interconnect with each other by utilizing an arm. In other words, each of the two DC nodes connect to each of the three AC phases via six arms (2×3=6). The six arms are composed of series connected state-of-the-art half-bridge or full-bridge modules. One primary drawback of these MMLC topologies is that the DC capacitors of the modules have to process single-phase AC power requirements which results in bulky capacitance requirements. On the other hand, the various approaches to providing a multilevel power converter architecture described herein with regard to FIGS. 1-13 eliminates this requirement by design, thereby enabling ultra-dense high voltage power conversion.

Turning now to the drawings, FIG. 1 is a schematic diagram of an example half-bridge module 100 for a minimal capacitor multilevel converter, according to an embodiment. The half-bridge module 100 includes a single capacitor (C) 102 with a capacitor voltage V_{Cup}, a first single-pole double-throw semiconductor switch (S₁) 110, and a second single-pole double-throw semiconductor switch (S₂) 120.

The first switch throw 112 of the first switch 110 and the first switch throw 122 of the second switch 120 are connected to respective voltage stiff nodes while the switch pole 116 of the first switch 110 and the switch pole 126 of the second switch 120 are connected to respective current stiff nodes. The second switch throw 114 of the first switch 110 and the second switch throw 124 of the second switch 120 are connected to each other via a node. The pole voltage (V_{P}) 130 is referenced differentially between terminals of the respective current stiff nodes, as depicted.

In contrast, a conventional half-bridge module may include a single switch, similar to either the first switch 110 or the second switch 120, with switch throws coupled to respective voltage stiff nodes and a switch pole connected to a current stiff node. For such a conventional half-bridge module, the pole voltage is referenced to one of the terminals of the voltage stiff node, such as the negative terminal.

For the half-bridge module 100, the switch state h(t) is on (e.g., assigned a value of 1) if the switch poles 116 and 126 are respectively connected to the switch throws 112 and 122 as depicted. The switch state h(t) is off (e.g., assigned a value of 0) if the switch poles 116 and 126 are instead respectively connected to the switch throws 114 and 124. The switches 110 and 120 are synchronized such that if one of the switch poles 116 or 126 of one of the switches 110 or 120, respectively, is connected to a switch throw 112 or 122, the other switch 120 or 110 is connected to a respective switch throw 122 or 112, and similarly for the switch throws 114 and 124. As a result, the switch state h(t) of 1 and the switch state h(t) of 0 result in pole voltages 130 of the capacitor voltage V_{Cup} and zero, respectively.

The switch poles 116 and 126 of the first and second switches 110 and 120 are respectively connected to a first inductor 118 and a second inductor 128 via the respective current stiff nodes. Although the inductors 118 and 128 are depicted at both poles, it should be appreciated that the inductors 118 and 128 are optional or may be realized using parasitics.

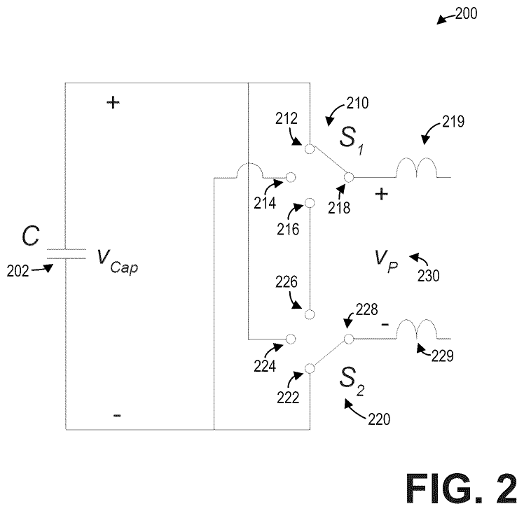

The half-bridge module 100 is a “half-bridge” because the output pole states lie between 0 and +V_{Cup}, whereas the output pole states for a full-bridge module may comprise −V_{Cup}, 0, or +V_{Cap}. As an illustrative example, FIG. 2 is a schematic diagram of an example full-bridge module 200 for a minimal capacitor multilevel converter, according to an embodiment. The full-bridge module 200 includes a capacitor (C) 202 with a capacitor voltage V_{Cup}, a first switch (S₁) 210, and a second switch (S₂) 220.

As depicted, the first switch 210 and the second switch 220 include single-pole triple-throw semiconductor switches. The first switch 210 includes a first switch throw 212 connected to the positive terminal of the capacitor 202, and a second switch throw 214 connected to the negative terminal of the capacitor 202. Similarly, the second switch 220 includes a first switch throw 222 connected to the negative terminal of the capacitor 202, and a second switch throw 224 connected to the positive terminal of the capacitor 202. The first switch 210 and the second switch 220 further include third switch throws 216 and 226, respectively, connected directly to each other via a node as depicted. Further, the switch poles 218 and 228 of the first and second switches 210 and 220 respectively are connected to respective current stiff nodes, where the pole voltage (V_{P}) 230 is referenced differentially between terminals of the current stiff nodes.

For the full-bridge module 200, the switch state h(t) is 1 if the switch poles 218 and 228 are respectively connected to the switch throws 212 and 222 as depicted. The switch state h(t) is 0 if the switch poles 218 and 228 are instead respectively connected to the switch throws 216 and 226. The switch state h(t) is −1 if the switch poles 218 and 228 are respectively connected to the switch throws 214 and 224. The switches 210 and 220 are synchronized such that the switch poles 218 and 228 of the switches 210 or 220, respectively, are connected to corresponding switch throws. As a result, the switch state h(t) of 1 results in a pole voltage 230 of the positive capacitor voltage +V_{Cap}, the switch state h(t) of 0 results in a pole voltage 230 of zero, and the switch state h(t) of −1 results in a negative capacitor voltage −V_{Cap}.

A conventional full-bridge module may include a two single-pole double-throw switches configured in parallel so that a differential pole voltage may be referenced between the switches, but two configurations of the switches in the conventional full-bridge module yield a pole voltage of zero because the switches are not synchronized. That is, in order to achieve the zero state for the conventional full-bridge module, the output pole must be connected to the positive capacitor terminal or the negative capacitor terminal.

In contrast, the full-bridge module 200 is fully differential where the zero state is isolated from the capacitor terminals. The advantage of a fully differential connection with the half-bridge and full-bridge modules 100 and 200 provided herein is that several such modules may be connected in series to provide multi-level power converters, as discussed further herein.

Similar to the half-bridge module 100, the full-bridge module 200 includes a first inductor 219 and a second inductor 229 respectively connected to the switch poles 218 and 228 of the first and second switches 210 and 220 via the respective current stiff nodes. Although the inductors 219 and 229 are depicted at both poles, it should be appreciated that the inductors 219 and 229 are optional or may be realized using parasitics.

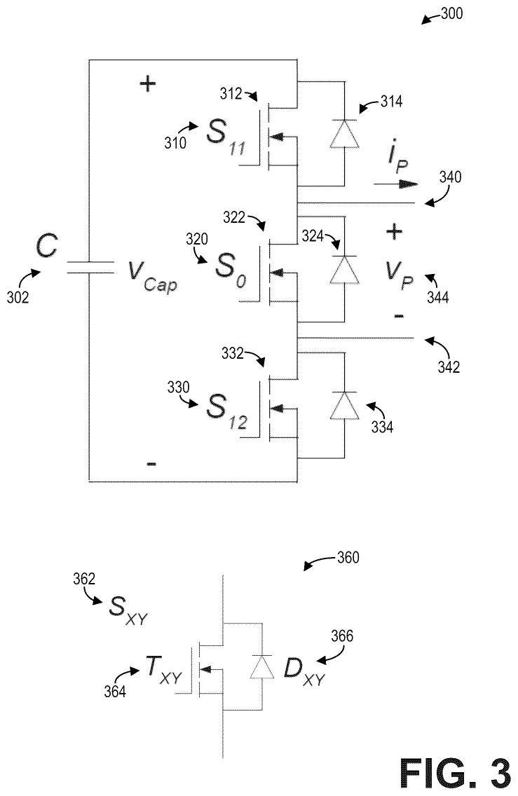

In some examples, half-bridge modules and full-bridge modules may be implemented with MOSFETs rather than semiconductor switches. For example, FIGS. 3-6 show how the half-bridge module 100 and the full-bridge module 200 may be implemented with MOSFETs. In particular, FIG. 3 is a schematic diagram of an example half-bridge module 300 for a minimal capacitor multilevel converter implemented with MOSFETs, according to an embodiment. The half-bridge module 300 includes a capacitor (C) 302, a first switch 310, a second switch 320, and a third switch 330, wherein the switches 310, 320, and 330 include MOSFETs.

In particular, as depicted by the diagram 360 illustrating nomenclature for a MOSFET switch 362, each MOSFET switch (SxY) 362 includes a forward conducting transistor (TxY) 364 and a reverse conducting diode (DXY) 366, which may include the body diode of the MOSFET device or switch 362 or an external device. The first switch (S₁₁) 310 thus includes a first transistor 312 and a first diode 314, the second switch (S₀) 320 includes a second transistor 322 and a second diode 324, and the third switch (S₁₂) 330 includes a third transistor 332 and a third diode 334. As depicted, a first pole 340 is connected between the first switch 310 and the second switch 320, while a second pole 342 is connected between the second switch 320 and the third switch 330, where the pole voltage (V_{P}) 344 is referenced differentially between the poles 340 and 342. When the switch state h(t) is 1 to achieve pole voltage 344 equal to the positive capacitor voltage +V_{Cup} with positive current i_{P}, the transistors 312 and 332 are turned on and carry the current, while for negative current i_{P}, the diodes 314 and 334 carry the current. For the zero state where the switch state h(t) is 0 such that the pole voltage 344 is zero, the second diode 324 carries the current for positive pole current i_{P} while the second transistor 322 carries the current for negative pole current i_{P}.

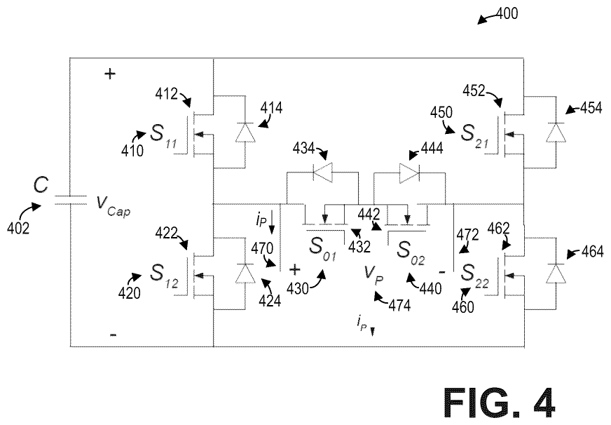

FIGS. 4-6 depict examples of how the full-bridge module 200 may be implemented with MOSFETs. In particular, FIG. 4 is a schematic diagram of a first example full-bridge module 400 for a minimal capacitor multilevel converter implemented with MOSFETs, according to an embodiment. The full-bridge module 400 includes a capacitor (C) 402, a first switch (S₁₁) 410, a second switch (S₁₂) 420, a third switch (S₀₁) 430, a fourth switch (S₀₂) 440, a fifth switch (S₂₁) 450, and a sixth switch (S₂₂) 460, wherein the switches 410, 420, 430, 440, 450, and 460 include MOSFETs.

The first switch 410 thus includes a first transistor 412 and a first diode 414, the second switch 420 includes a second transistor 422 and a second diode 424, the third switch 430 includes a third transistor 432 and a third diode 434, the fourth switch 440 includes a fourth transistor 442 and a fourth diode 444, the fifth switch 450 includes a fifth transistor 452 and a fifth diode 454, and the sixth switch 460 includes a sixth transistor 462 and a sixth diode 464. As depicted, a first pole 470 is connected to the node between the first switch 410, the second switch 420, and the third switch 430, while a second pole 472 is connected to the node between the fourth switch 440, the fifth switch 450, and the sixth switch 460, where the pole voltage (V_{P}) 474 is referenced differentially between the poles 470 and 472.

When the switch state h(t) is 1 to achieve pole voltage 474 equal to the positive capacitor voltage +V_{Cup} with positive current +i_{P}, the transistors 412 and 462 are turned on and carry the current, while for negative current −i_{P}, the diodes 414 and 464 carry the current. For the zero state where the switch state h(t) is 0 such that the pole voltage 474 is zero, the transistor 442 and the diode 434 carry the current for positive pole current +i_{P} while the diode 444 and the transistor 432 carry the current for negative pole current −i_{P}. For the switch state h(t) equal to −1 such that the pole voltage 474 is the negative capacitor voltage −V_{Cup}, the diode 424 and the diode 454 carry the positive pole current +i_{P} while the transistor 422 and the transistor 452 carry the negative pole current −i_{P}.

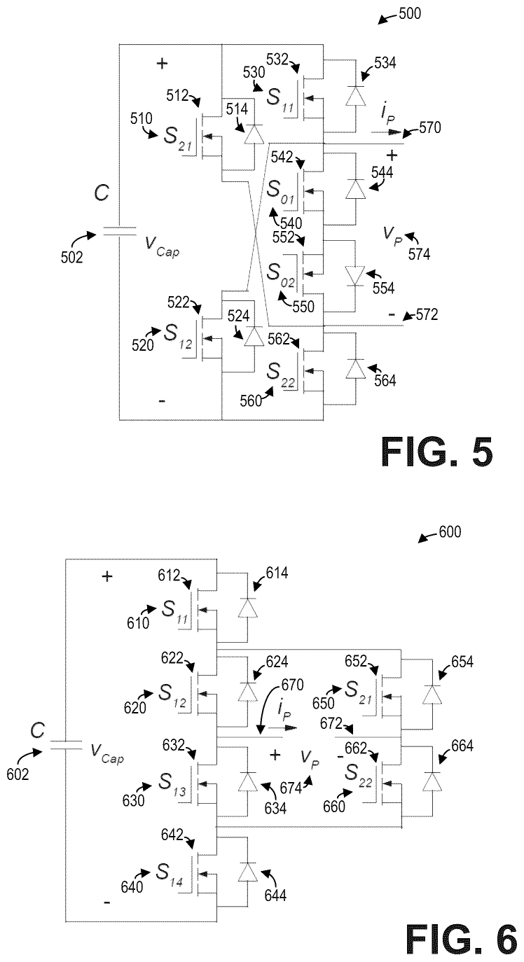

FIG. 5 is a schematic diagram of a second example full-bridge module 500 for a minimal capacitor multilevel converter implemented with MOSFETs, according to an embodiment. The full-bridge module 500 includes a capacitor (C) 502, a first switch (S₂₁) 510, a second switch (S₁₂) 520, a third switch (S₁₁) 530, a fourth switch (S₀₁) 540, a fifth switch (S₀₂) 550, and a sixth switch (S₂₂) 560 arranged as depicted, wherein the switches 510, 520, 530, 540, 550, and 560 include MOSFETs.

The first switch 510 thus includes a first transistor 512 and a first diode 514, the second switch 520 includes a second transistor 522 and a second diode 524, the third switch 530 includes a third transistor 532 and a third diode 534, the fourth switch 540 includes a fourth transistor 542 and a fourth diode 544, the fifth switch 550 includes a fifth transistor 552 and a fifth diode 554, and the sixth switch 560 includes a sixth transistor 562 and a sixth diode 564. As depicted, a first pole 570 is connected to the node between the second switch 520, the third switch 530, and the fourth switch 540, while a second pole 572 is connected to the node between the first switch 510, the fifth switch 550, and the sixth switch 560, where the pole voltage (V_{P}) 574 is referenced differentially between the poles 570 and 572. Note the flipped orientation of the fifth diode 554 relative to the fourth diode 544, as well as the respective corresponding transistors, due to the positioning of the diodes 544 and 554 relative to the poles 570 and 572, respectively.

When the switch state h(t) is 1 to achieve pole voltage 574 equal to the positive capacitor voltage +V_{Cup} with positive current +i_{P}, the transistors 532 and 562 are turned on and carry the current, while for negative current −i_{P}, the diodes 534 and 564 carry the current. For the zero state where the switch state h(t) is 0 such that the pole voltage 574 is zero, the diode 544 and the transistor 552 carry the current for positive pole current +i_{P} while the transistor 542 and the diode 554 carry the current for negative pole current −i_{P}. For the switch state h(t) equal to −1 such that the pole voltage 574 is the negative capacitor voltage −V_{Cup}, the diode 524 and the diode 514 carry the positive pole current +i_{P} while the transistor 522 and the transistor 512 carry the negative pole current −i_{P}.

FIG. 6 is a schematic diagram of a third example full-bridge module 600 for a minimal capacitor multilevel converter implemented with MOSFETs, according to an embodiment. The full-bridge module 600 includes a capacitor (C) 602, a first switch (S₁₁) 610, a second switch (S₁₂) 620, a third switch (S₁₃) 630, a fourth switch (S₁₄) 640, a fifth switch (S₂₁) 650, and a sixth switch (S₂₂) 660 arranged as depicted, wherein the switches 610, 620, 630, 640, 650, and 660 include MOSFETs.

The first switch 610 thus includes a first transistor 612 and a first diode 614, the second switch 620 includes a second transistor 622 and a second diode 624, the third switch 630 includes a third transistor 632 and a third diode 634, the fourth switch 640 includes a fourth transistor 642 and a fourth diode 644, the fifth switch 650 includes a fifth transistor 652 and a fifth diode 654, and the sixth switch 660 includes a sixth transistor 662 and a sixth diode 664. As depicted, a first pole 670 is connected to the node between the second switch 620 and the third switch 630, while a second pole 672 is connected to the node between the fifth switch 650 and the sixth switch 660, where the pole voltage (V_{P}) 674 is referenced differentially between the poles 670 and 672.

When the switch state h(t) is 1 to achieve pole voltage 674 equal to the positive capacitor voltage +V_{Cup} with positive current +i_{P}, the transistors 612, 622, 662, and 642 are turned on and carry the current, while for negative current −i_{P}, the diodes 614, 624, 664, and 644 carry the current. For the zero state where the switch state h(t) is 0 such that the pole voltage 674 is zero, the transistor 622 and the diode 654 or the diode 634 and the transistor 662 carry the current for positive pole current +i_{P} while the diode 624 and the transistor 652 or the transistor 632 and the diode 664 carry the current for negative pole current −i_{P}. For the switch state h(t) equal to −1 such that the pole voltage 674 is the negative capacitor voltage −V_{Cup}, the diodes 614, 654, 634, and 644 carry the positive pole current +i_{P} while the transistors 612, 652, 632, and 642 carry the negative pole current −i_{P}.

It should be appreciated that alternative and reduced versions of the switch embodiments depicted in FIGS. 4-6 are possible. For example, IGBTs may be used for low switching frequency operation or diodes may be used for some or many of the switches for unidirectional current flow, and so on. While the particular choice of half-bridge module or full-bridge module may be based on application specifications, it should be appreciated that the full-bridge modules 400 and 500 may exhibit lower conduction losses compared to the full-bridge module 600 since only two devices conduct during any given switch state. It should be appreciated that the half-bridge and full-bridge modules described herein may be implemented with other transistor types, including but not limited to integrated gate-commutated thyristors (IGCTs), high-electron-mobility transistors (HEMTs) including gallium nitride-based (GaN) HEMTs, and so on. It should further be appreciated that the modules described herein may be implemented with transistors currently under development or to be developed in the future. Alternative implementations may be considered according to advantages and tradeoffs inherent to the type of transistor and their impact on the application. For example, IGCTs may result in lower conduction losses but are suitable in low switching frequency applications. Further, MOSFETs inherently include parasitic diodes, also referred to as body-diodes or anti-parallel diodes. In some examples, IGBTs could be designed without body-diodes and implemented as described herein. IGCTs also include body-diodes. Based on application trade-offs between cost and loss calculations, external diodes may or may not be added in view of low losses and improved behavior versus cost.

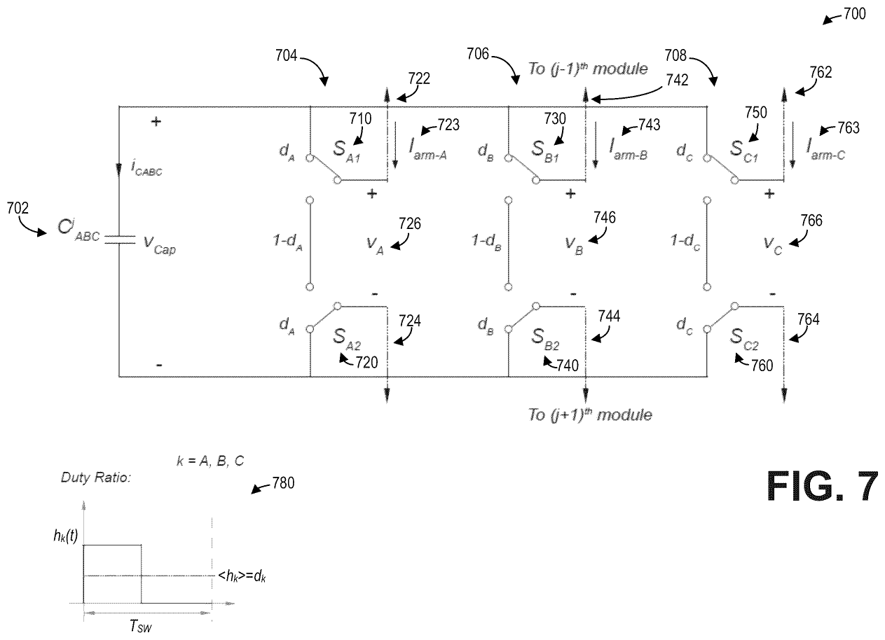

While the half-bridge modules and full-bridge modules described hereinabove include advantageous and novel approaches to power conversion over conventional systems, the advantages of the modules described hereinabove are readily observed when implemented with three-phase AC systems. As an illustrative example, FIG. 7 is a schematic diagram of an example three-phase half-bridge module 700 in a minimal capacitor multilevel converter, according to an embodiment. The three-phase half-bridge module 700 includes a capacitor (Cj_{ABC}) 702 with a capacitor voltage V_{Cup}, a first half-bridge module 704 for a first phase A, a second half-bridge module 706 for a second phase B, and a third half-bridge module 708 for a third phase C. As depicted, the three-phase half-bridge module 700 is the jth module of a plurality of modules in an integrated arm of a minimal capacitor multilevel converter, where the three-phase half-bridge module 700 is coupled to a (j−1)th module and a (j+1)th module in an integrated arm as discussed further herein.

Each of the half-bridge modules 704, 706, and 708 includes half-bridge modules such as the half-bridge module 100 described hereinabove with regard to FIG. 1. To that end, the first half-bridge module 704 includes a first switch 710 and a second switch 720. The switch poles of the first switch 710 and the second switch 720 are coupled to a first pole 722 and a second pole 724, respectively, wherein the pole voltage (V_{A}) 726 for the first phase A is referenced differentially between the poles 722 and 724. Further, the first pole 722 connects to the (j−1)th module while the second pole 724 connects to the (j+1)th module. Similarly, the second half-bridge module 706 includes a first switch 730 and a second switch 740. The switch poles of the first switch 730 and the second switch 740 are coupled to a first pole 742 and a second pole 744, respectively, wherein the pole voltage (VB) 746 for the second phase B is referenced differentially between the poles 742 and 744. Further, the first pole 742 connects to the (j−1)th module while the second pole 744 connects to the (j+1)th module. Further still, the third half-bridge module 708 includes a first switch 750 and a second switch 760. The switch poles of the first switch 750 and the second switch 760 are coupled to a first pole 762 and a second pole 764, respectively, wherein the pole voltage (V_{C}) 766 for the third phase C is referenced differentially between the poles 762 and 764. Further, the first pole 762 connects to the (j−1)th module while the second pole 764 connects to the (j+1)th module.

Graph 780 illustrates the duty ratios that may characterize the current through the module capacitor 702. The duty ratio is defined as the average value of the switch state variable h over one switching period T_{SW} (which includes the inverse of the switching frequency ƒsw). Considering a half-bridge module such as the half-bridge module 704, for example, when the switch state is 1, the pole is connected to the capacitor and provides a path for the pole current. The pole current for each module may include a first current 723 for first half-bridge module 704 (I_{arm-A}, also referred to as I_{A}), a second current 743 for second half-bridge module 706 (I_{arm-B}, also referred to as I_{B}), and a third current 763 for third half-bridge module 708 (I_{arm-C}, also referred to as I_{C}). The capacitor current is zero when h is zero as the capacitor is bypassed. The average value of the switch state variable h represents the duty ratio d of the switch and aids in quantifying switching variables. The integrated module structure of the three-phase half-bridge module 700 arises due to the differentially connected pole voltages, where the integration of the three AC phases to a common capacitor 702 eliminates the need of single-phase AC power processing requirements of the three phases. In particular, under balanced three-phase AC systems, the currents of the three phases cancel out according to the following equation:

I_{A}+I_{B}+I_{C}=0.

Hence, the net AC power processing requirements of the capacitor 702 per switching cycle T_{SW} are ideally zero. In this way, minimally-sized energy storage elements, such as capacitors, may be used for power conversion. For example, the current for the capacitor 702 may be expressed as:

$${i}_{{C}_{ABC}} = {d}_{A} \times ( \frac{{I}_{dc}}{3} + \frac{{I}_{A}}{2} ) + {d}_{B} \times ( \frac{{I}_{dc}}{3} + \frac{{I}_{B}}{2} ) + {d}_{C} \times ( \frac{{I}_{dc}}{3} + \frac{{I}_{C}}{2} ) ,$$

where the parenthetical terms comprise the arm currents for each phase including current I_{arm-A} for phase A, current I_{arm-B} for phase B, and current I_{arm-C} for phase C, and wherein dₖ is the duty ratio of the three AC phases:

$${d}_{k} = \frac{( \frac{{V}_{dc}}{2} - {V}_{k} )}{{V}_{Cap}} .$$

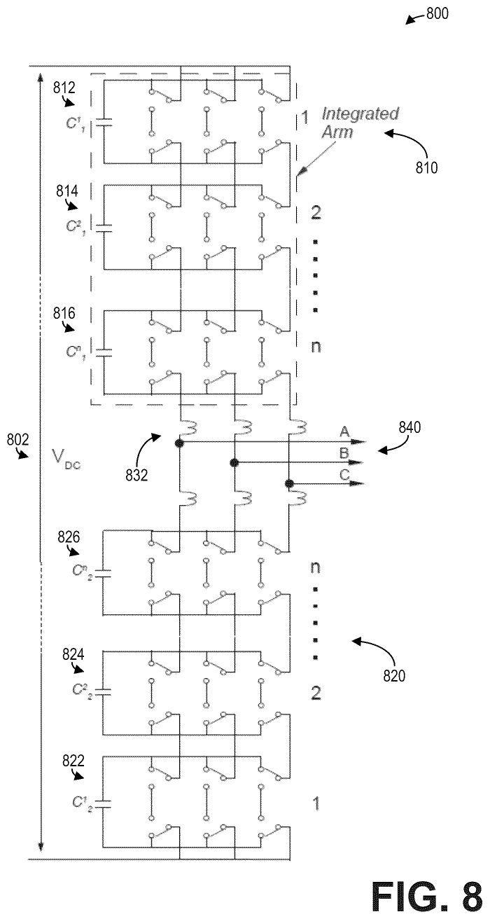

This duty ratio is applicable to the modules of the first integrated arm 810 described further herein with regard to FIG. 8. Similarly, for the second integrated arm 820 of FIG. 8, the duty ratio for the modules may be expressed as:

$${d}_{k} = \frac{( \frac{{V}_{dc}}{2} - {V}_{k} )}{{V}_{Cap}} .$$

It should be appreciated that these duty ratio expressions arise from a certain modulation strategy that may be used for this module topology, and that other modulation strategies are possible with correspondingly different duty ratios.

The DC module capacitor current features phase currents of the three AC phases. Substituting the expression for dx into the expression for the capacitor current:

$${i}_{{C}_{ABC}} = \frac{1}{{V}_{Cap}} \text{} ( \frac{{V}_{dc} {I}_{dc}}{2} - \frac{{V}_{A} {I}_{A} + {V}_{B} {I}_{B} + {V}_{C} {I}_{C}}{2} + {V}_{dc} \frac{{I}_{A} + {I}_{B} + {I}_{C}}{4} - {I}_{dc} \frac{{V}_{A} + {V}_{B} + {V}_{C}}{3} ) .$$

The first two terms are zero per switching period, the third term is zero per switching period, and the fourth term is zero per switching period. In other words, under balanced three-phase AC systems, the sum of the three-phase voltages and currents are zero. Therefore, the average DC module capacitor current per switching cycle is ideally zero, thereby enabling minimally-sized module capacitors, hence the name minimal capacitor multilevel converter. As discussed further herein, the minimal capacitor multilevel converter topology may use half-bridge or full-bridge modules based on DC and AC design specifications.

FIG. 8 is a schematic diagram of an example DC-AC minimal capacitor multilevel converter 800 comprising half-bridge modules, according to an embodiment. In particular, the DC-AC minimal capacitor multilevel converter 800 includes n modules for DC-AC power conversion. The integrated arm structure based on the module designs of FIGS. 1 and 2 enable the differential output poles of the modules to be connected in series for high-voltage power conversion.

The DC-AC minimal capacitor multilevel converter 800 converts DC voltage (V_{DC}) 802 to three-phase AC voltage 840, as depicted. It should be noted that AC to DC conversion is also possible with this topology where power transfer takes place from AC to DC. The converter 800 may further include a bi-directional converter where power transfer may occur from DC to AC or from AC to DC at different times, depending on system requirements. A first integrated arm 810 includes n half-bridge modules, including at least a first half-bridge module 812, a second half-bridge module 814, and an nth half-bridge module 816. A second integrated arm 820 includes n half-bridge modules, including at least a first half-bridge module 822, a second half-bridge module 824, and an nth half-bridge module 826. Each half-bridge module may include the half-bridge module 700 described hereinabove with regard to FIG. 7. Further, as depicted, in some examples the DC-AC minimal capacitor multilevel converter 800 may optionally include a plurality of inductors 832 positioned between the integrated arms. Further, the converter 800 may be implemented with full-bridge modules as described herein based on DC and AC specifications.

The total capacitance requirements only need to meet minimal power processing requirements in balanced AC systems as described further herein. As an illustrative example, for DC-AC conversion, conventional approaches to modular multilevel converts depend on capacitance requirements that are substantially larger than the capacitance needs for the minimal capacitor multilevel converters described herein for the same power. For example, for a 10 kV DC to 4.16 kV three-phase 60 Hz AC power converter, converters configured with ten levels or modules and a switching frequency of 20 kHz utilize significantly difference capacitance per module to achieve the same DC-AC conversion. In particular, conventional modular multilevel converters may use 2 mF per module with a total capacitance of 120 mF, whereas the minimal capacitor multilevel converter provided herein may use 10 μF per module with a total capacitance of 200 μF, or orders of magnitude less capacitance for the same technical problem. To emphasize, the 10 μF capacitance of the minimal capacitor multilevel converter is shared among the three phases in each module, whereas the capacitance for the conventional modular multilevel converter uses 2 mF capacitance per phase in each module to maintain the same ripple voltage.

In addition to using fewer capacitors, the minimal capacitor multilevel converter topology needs less capacitance for the same per-unit power conversion. This enables the use of film capacitors as opposed to electrolytic capacitors which are typically used in modular multilevel converter topology due to the voluminous capacitance requirements. Hence, minimal capacitor multilevel converters may be expected to have a higher lifespan compared to modular multilevel converters, since electrolytic capacitors are typically the bottleneck of a converter lifetime.

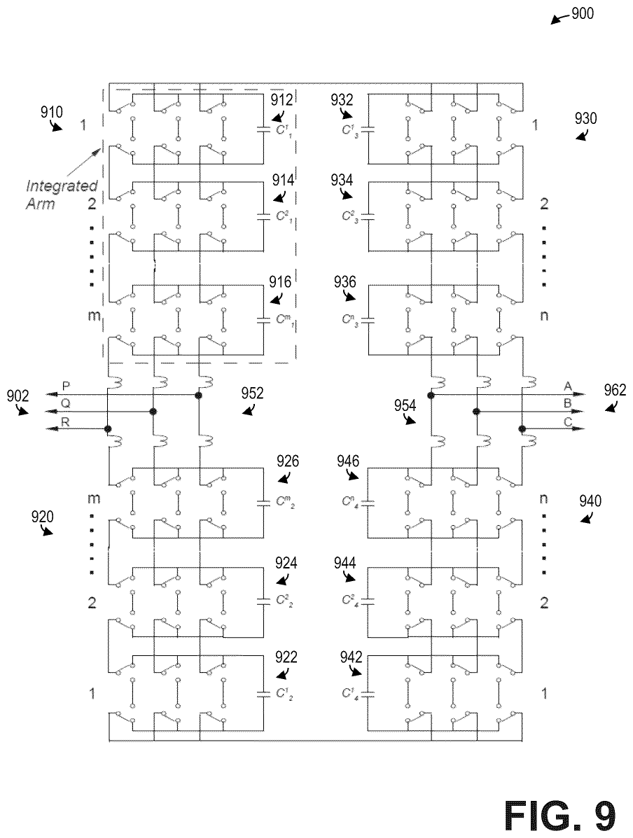

FIGS. 9-11 illustrate AC-AC topologies for the minimal capacitor multilevel converter approach described herein. In particular, FIG. 9 is a schematic diagram illustrating an example AC-AC cascaded minimal capacitor multilevel converter 900 comprising half-bridge modules, according to an embodiment. The AC-AC cascaded minimal capacitor multilevel converter 900 includes AC-DC power conversion followed by DC-AC power conversion in order to perform AC-AC power conversion of three-phase AC voltages 902 to three-phase AC voltages 962. The intermediate high-voltage DC bus may optionally include a DC-link capacitor or inductor bank, in some examples. As depicted, the first integrated arm 910 comprises m half-bridge modules, including at least a first half-bridge module 912, a second half-bridge module 914, and an mth half-bridge module 916. The second integrated arm 920 also comprises m half-bridge modules, including at least a first half-bridge module 922, a second half-bridge module, 924, and an mth half-bridge module 926. The third integrated arm 930 comprises n half-bridge modules, including at least a first half-bridge module 932, a second half-bridge module 934, and an nth half-bridge module 936. The fourth integrated arm 940 also comprises n half-bridge modules, including at least a first half-bridge module 942, a second half-bridge module 944, and an nth half-bridge module 946. Further, as depicted, the AC-AC cascaded minimal capacitor multilevel converter 900 may optionally include a plurality of inductors 952 and a plurality of inductors 954. Further still, it should be appreciated that the converter 900 may be implemented with full-bridge modules described herein based on source and load specifications.

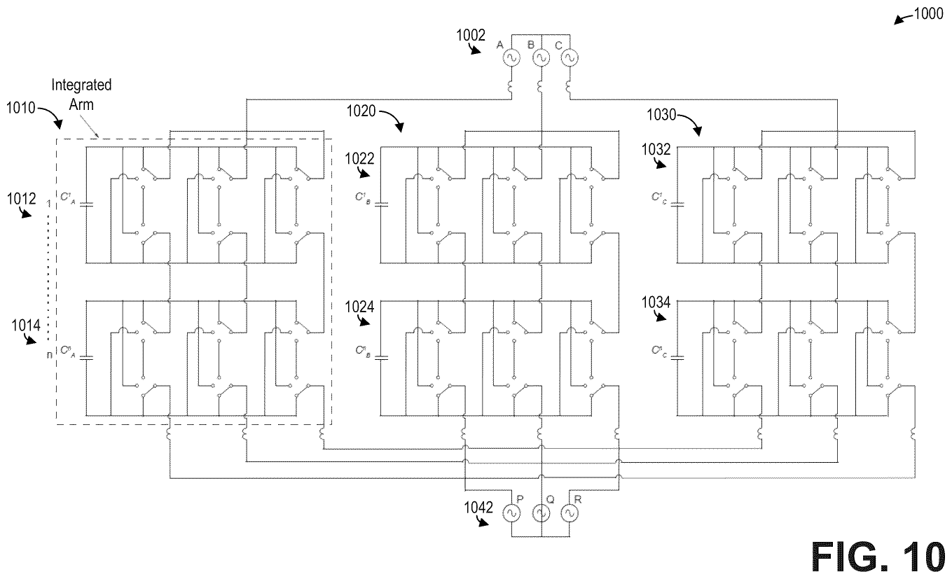

FIG. 10 is a schematic diagram illustrating an example AC-AC direct minimal capacitor multilevel converter 1000 comprising full-bridge modules, according to an embodiment. The AC-AC direct minimal capacitor multilevel converter 1000 converts three-phase AC voltage 1002 to three-phase AC voltage 1042. The converter 1000 includes a first integrated arm 1010 for the first phase A comprising n full-bridge modules, ranging from a first full-bridge module 1012 to an nth full-bridge module 1014. The converter 1000 further includes a second integrated arm 1020 for the second phase B comprising n full-bridge modules, ranging from a first full-bridge module 1022 to an nth full-bridge module 1024. The converter 1000 further includes a third integrated arm 1030 for the third phase C comprising n full-bridge modules, ranging from a first full-bridge module 1032 to an nth full-bridge module 1034. The full-bridge modules are based on the full-bridge module 200 described hereinabove with regard to FIG. 2, built into three-phase full-bridge modules similar to the three-phase half-bridge module 700 described hereinabove with regard to FIG. 7. As depicted, the converter 1000 may include an inductor for each phase of the three-phase AC voltage 1002 input to the converter 1000, where each phase voltage is provided to a respective integrated arm as depicted. Respective inductors may further be provided for each of the three-phase outputs of each integrated arm, where respective phases output by each integrated arm are combined to form the three-phase voltage output 1042 as depicted. Although the integrated arm structure of the converter 1000 eliminates single-phase AC power processing requirements from PQR phases, each of the integrated arms still processes the ABC phase requirements individually.

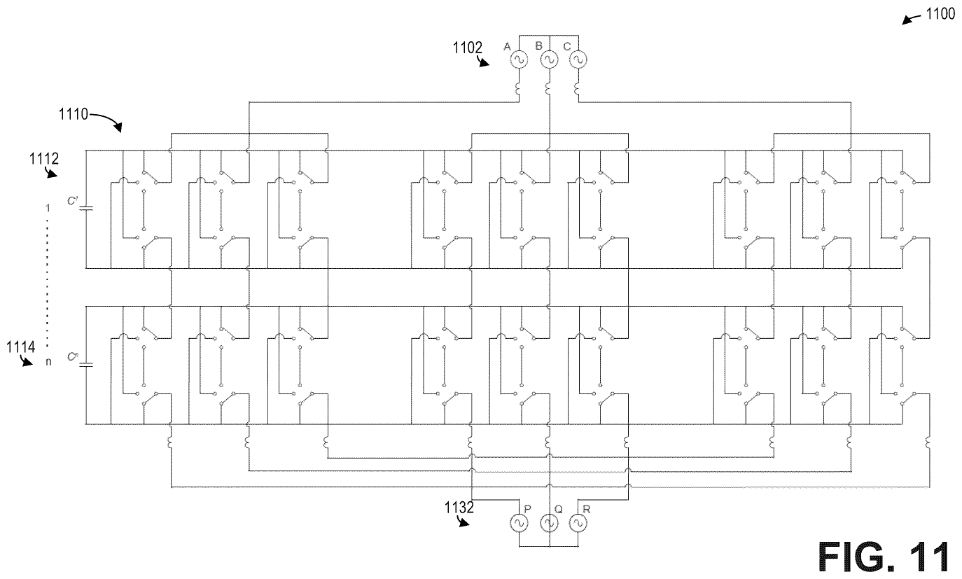

FIG. 11 is a schematic diagram illustrating an example AC-AC direct reduced minimal capacitor multilevel converter 1100 comprising full-bridge modules configured as a single arm, according to an embodiment. The AC-AC direct reduced minimal capacitor multilevel converter 1100 converts the three-phase AC voltages 1102 to the three-phase AC voltages 1132. The converter 1100 includes a single integrated arm 1110 formed from n full-bridge modules, ranging from a first full-bridge module 1112 to an nth full-bridge module 1114. While the converter 1100 further reduces net capacitance requirements, it should be appreciated that careful control should be taken to avoid circulating currents. It should be further appreciated that the particular AC-AC converter topology for a given application may be selected from the various examples provided herein based on the specifications of the converter application.

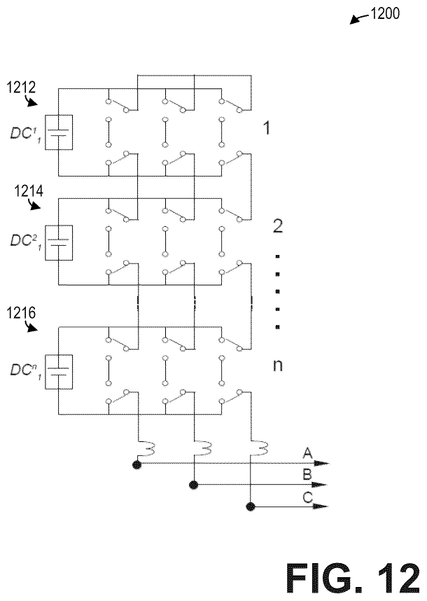

As an additional example, FIG. 12 is a schematic diagram illustrating an example distributed DC-AC minimal capacitor multilevel converter 1200 comprising half-bridge modules, according to an embodiment. In particular, the DC-AC minimal capacitor multilevel converter 1200 includes n modules for DC-AC power conversion. It should be noted that AC to DC conversion is also possible with this topology where power transfer takes place from AC to DC. The converter 1200 may further include a bi-directional converter where power transfer may occur from DC to AC or from AC to DC at different times, depending on system requirements. The DC-AC minimal capacitor multilevel converter 1200 includes n half-bridge modules, including at least a first half- bridge module 1212, a second half-bridge module 1214, and an nth half-bridge module 1216.

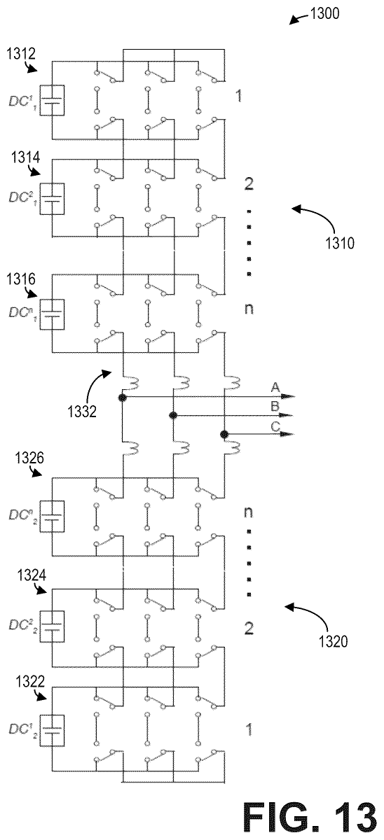

As another example, FIG. 13 is a schematic diagram illustrating another example distributed DC-AC minimal capacitor multilevel converter 1300 comprising half-bridge modules, according to an embodiment. In particular, the DC-AC minimal capacitor multilevel converter 1300 includes n modules for DC-AC power conversion. It should be noted that AC to DC conversion is also possible with this topology where power transfer takes place from AC to DC. The converter 1300 may further include a bi-directional converter where power transfer may occur from DC to AC or from AC to DC at different times, depending on system requirements.

The integrated arm structure based on the module designs of FIGS. 1 and 2 enable the differential output poles of the modules to be connected in series for high-voltage power conversion. A first integrated arm 1310 includes n half-bridge modules, including at least a first half-bridge module 1312, a second half-bridge module 1314, and an nth half-bridge module 1316.

A second integrated arm 1320 includes n half-bridge modules, including at least a first half-bridge module 1322, a second half-bridge module 1324, and an nth half-bridge module 1326. Each half-bridge module may include the half-bridge module 700 described hereinabove with regard to FIG. 7. Further, as depicted, in some examples the DC-AC minimal capacitor multilevel converter 1300 may optionally include a plurality of inductors 1332 positioned between the integrated arms.

It should be appreciated that other embodiments may use full-bridge modules if needed for a given application. These topologies are suitable for applications with distributed DC sources or loads. The DC module capacitors are replaced by DC sources or loads. As an example, the DC sources or loads may be distributed energy storage batteries connected to the three-phase AC grid. With increased penetration of renewable energy sources to the grid, which are intermittent sources by nature, the need of such storage systems will expand.

Thus, half-bridge modules and full-bridge modules are provided that enable the integrated connection of three-phase AC voltages to a minimally-sized common capacitor, as well as the series and/or parallel connection of a plurality of such circuits to realize medium to high voltage power converters. The innovative and unique module designs enable the derivation of several DC-AC and AC-AC power converters. The combination of the half-bridge modules and full-bridge modules provided herein are exemplary and non-limiting, and it should be appreciated that the modules may be adapted for other applications.

The description of embodiments has been presented for purposes of illustration and description. Suitable modifications and variations to the embodiments may be performed in light of the above description or may be acquired from practicing the methods.

The disclosure also provides support for a power converter, comprising: a capacitor, and a circuit comprising a first switch and a second switch, a switch throw of the first switch coupled to a first terminal of the capacitor and a switch throw of the second switch coupled to a second terminal of the capacitor, wherein a pole voltage is fully differential between a first pole of the first switch and a second pole of the second switch, and wherein the first pole and the second pole are isolated from the capacitor when the circuit is in a zero state. In a first example of the power converter, the first switch and the second switch are synchronized. In a second example of the power converter, optionally including the first example, the power converter further comprises: a second circuit comprising a third switch and a fourth switch, a switch throw of the third switch coupled to the first terminal of the capacitor and a switch throw of the fourth switch coupled to the second terminal of the capacitor, and a third circuit comprising a fifth switch and a sixth switch, a switch throw of the fifth switch coupled to the first terminal of the capacitor and a switch throw of the sixth switch coupled to the second terminal of the capacitor. In a third example of the power converter, optionally including one or both of the first and second examples, a second pole voltage is fully differential between a third pole of the third switch and a fourth pole of the fourth switch, wherein the third pole and the fourth pole are isolated from the capacitor when the second circuit is in a zero state, wherein a third pole voltage is fully differential between a fifth pole of the fifth switch and a sixth pole of the sixth switch, wherein the fifth pole and the sixth pole are isolated from the capacitor when the third circuit is in a zero state. In a fourth example of the power converter, optionally including one or more or each of the first through third examples, a second switch throw of the first switch is directly coupled to a second switch throw of the second switch, and wherein the circuit is in the zero state when the first pole contacts the second switch throw of the first switch and the second pole contacts the second switch throw of the second switch. In a fifth example of the power converter, optionally including one or more or each of the first through fourth examples, a third switch throw of the first switch is coupled to the second terminal of the capacitor, and wherein a third switch throw of the second switch is coupled to the first terminal of the capacitor.

The disclosure also provides support for a power converter, comprising: a plurality of modules, wherein each module of the plurality of modules comprises: a capacitor, and a circuit comprising a first switch and a second switch, a switch throw of the first switch coupled to a first terminal of the capacitor and a switch throw of the second switch coupled to a second terminal of the capacitor, wherein a pole voltage is fully differential between a first pole of the first switch and a second pole of the second switch, and wherein the first pole and the second pole are isolated from the capacitor when the circuit is in a zero state, wherein the plurality of modules are coupled in series, wherein a second pole of a second switch of a first module of the plurality of modules is coupled to a first pole of a first switch of a second module of the plurality of modules. In a first example of the power converter, each module of the plurality of modules further comprises: a second circuit comprising a third switch and a fourth switch, a switch throw of the third switch coupled to the first terminal of the capacitor and a switch throw of the fourth switch coupled to the second terminal of the capacitor, and a third circuit comprising a fifth switch and a sixth switch, a switch throw of the fifth switch coupled to the first terminal of the capacitor and a switch throw of the sixth switch coupled to the second terminal of the capacitor. In a second example of the power converter, optionally including the first example for each module of the plurality of modules, a second pole voltage is fully differential between a third pole of the third switch and a fourth pole of the fourth switch, wherein the third pole and the fourth pole are isolated from the capacitor when the second circuit is in a zero state, wherein a third pole voltage is fully differential between a fifth pole of the fifth switch and a sixth pole of the sixth switch, wherein the fifth pole and the sixth pole are isolated from the capacitor when the third circuit is in a zero state. In a third example of the power converter, optionally including one or both of the first and second examples for each module of the plurality of modules, a second switch throw of the first switch is directly coupled to a second switch throw of the second switch, and the circuit is in the zero state when the first pole contacts the second switch throw of the first switch and the second pole contacts the second switch throw of the second switch. In a fourth example of the power converter, optionally including one or more or each of the first through third examples, a first module of the plurality of modules is coupled to a direct current voltage, and wherein a last module of the plurality of modules in series outputs a converted alternating current voltage. In a fifth example of the power converter, optionally including one or more or each of the first through fourth examples, a first alternating current is input to a first module of the plurality of modules, and wherein a last module of the plurality of modules in series outputs a converted alternating current. In a sixth example of the power converter, optionally including one or more or each of the first through fifth examples, a single phase of a three-phase alternating current voltage is input to a first module of the plurality of modules, and wherein a last module of the plurality of modules in series outputs a converted three-phase alternating current voltage. In a seventh example of the power converter, optionally including one or more or each of the first through sixth examples, each module of the plurality of modules comprises a half-bridge module or a full-bridge module.

The disclosure also provides support for a power converter, comprising: a plurality of modules configured in series, wherein each module comprises: a capacitor, and a circuit comprising a plurality of switches coupled to the capacitor, wherein a pole voltage is fully differential between a first pole and a second pole, and wherein the first pole and the second pole are isolated from the capacitor when the circuit is in a zero state. In a first example of the power converter, the plurality of switches comprise single-pole double-throw semiconductor switches or single-pole triple-throw semiconductor switches. In a second example of the power converter, optionally including the first example, the plurality of switches comprise IGBTs, HEMTs, IGCTs, or MOSFET devices. In a third example of the power converter, optionally including one or both of the first and second examples, the plurality of modules are configured to convert a direct current voltage to a three-phase alternating current voltage. In a fourth example of the power converter, optionally including one or more or each of the first through third examples, the plurality of modules are configured to convert a first three-phase alternating current voltage to a second three-phase alternating current voltage. In a fifth example of the power converter, optionally including one or more or each of the first through fourth examples, the plurality of modules are configured to convert a first three-phase alternating current voltage to a direct current voltage, and to convert the direct current voltage to a second three-phase alternating current voltage.

Aspects of the present disclosure are described herein with reference to flowchart illustrations and/or block diagrams of methods, apparatus, and computer program products according to the embodiments disclosed herein. Insofar as such block diagrams, flowcharts, and/or examples contain one or more functions and/or operations, it will be understood by those of skill in the art that each function and/or operation within such block diagrams, flowcharts, or examples can be implemented, individually and/or collectively, by computer readable instructions using a wide range of hardware, software, firmware, or virtually any combination thereof. The described systems are exemplary in nature, and may include additional elements and/or omit elements. The subject matter of the present disclosure includes all novel and non-obvious combinations and sub-combinations of the various systems and configurations, and other features, functions, and/or properties disclosed. Thus, the methods may be performed by executing stored instructions on machine readable storage media with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

As used herein, the terms “system” or “module” may include a hardware and/or software system that operates to perform one or more functions. For example, a module or system may include a computer processor, controller, or other logic-based device that performs operations based on instructions stored on a tangible and non-transitory computer readable storage medium, such as a computer memory. Alternatively, a module or system may include a hard-wired device that performs operations based on hard-wired logic of the device. Various modules or units shown in the attached figures may represent the hardware that operates based on software or hardwired instructions, the software that directs hardware to perform the operations, or a combination thereof.

As used in this application, an element or step recited in the singular and preceded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

1. A power converter, comprising:
a capacitor; and
a circuit comprising a first switch and a second switch, a switch throw of the first switch coupled to a first terminal of the capacitor and a switch throw of the second switch coupled to a second terminal of the capacitor, wherein a pole voltage is fully differential between a first pole of the first switch and a second pole of the second switch, and wherein the first pole and the second pole are isolated from the capacitor when the circuit is in a zero state.

2. The power converter of claim 1, wherein the first switch and the second switch are synchronized.

3. The power converter of claim 1, further comprising:
a second circuit comprising a third switch and a fourth switch, a switch throw of the third switch coupled to the first terminal of the capacitor and a switch throw of the fourth switch coupled to the second terminal of the capacitor; and
a third circuit comprising a fifth switch and a sixth switch, a switch throw of the fifth switch coupled to the first terminal of the capacitor and a switch throw of the sixth switch coupled to the second terminal of the capacitor.

4. The power converter of claim 3, wherein a second pole voltage is fully differential between a third pole of the third switch and a fourth pole of the fourth switch, wherein the third pole and the fourth pole are isolated from the capacitor when the second circuit is in a zero state, wherein a third pole voltage is fully differential between a fifth pole of the fifth switch and a sixth pole of the sixth switch, wherein the fifth pole and the sixth pole are isolated from the capacitor when the third circuit is in a zero state.

5. The power converter of claim 1, wherein a second switch throw of the first switch is directly coupled to a second switch throw of the second switch, and wherein the circuit is in the zero state when the first pole contacts the second switch throw of the first switch and the second pole contacts the second switch throw of the second switch.

6. The power converter of claim 5, wherein a third switch throw of the first switch is coupled to the second terminal of the capacitor, and wherein a third switch throw of the second switch is coupled to the first terminal of the capacitor.

7. A power converter, comprising:
a plurality of modules, wherein each module of the plurality of modules comprises:
a capacitor; and
a circuit comprising a first switch and a second switch, a switch throw of the first switch coupled to a first terminal of the capacitor and a switch throw of the second switch coupled to a second terminal of the capacitor, wherein a pole voltage is fully differential between a first pole of the first switch and a second pole of the second switch, and wherein the first pole and the second pole are isolated from the capacitor when the circuit is in a zero state;
wherein the plurality of modules are coupled in series, wherein a second pole of a second switch of a first module of the plurality of modules is coupled to a first pole of a first switch of a second module of the plurality of modules.

8. The power converter of claim 7, wherein each module of the plurality of modules further comprises:
a second circuit comprising a third switch and a fourth switch, a switch throw of the third switch coupled to the first terminal of the capacitor and a switch throw of the fourth switch coupled to the second terminal of the capacitor; and
a third circuit comprising a fifth switch and a sixth switch, a switch throw of the fifth switch coupled to the first terminal of the capacitor and a switch throw of the sixth switch coupled to the second terminal of the capacitor.

9. The power converter of claim 8, wherein, for each module of the plurality of modules, a second pole voltage is fully differential between a third pole of the third switch and a fourth pole of the fourth switch, wherein the third pole and the fourth pole are isolated from the capacitor when the second circuit is in a zero state, wherein a third pole voltage is fully differential between a fifth pole of the fifth switch and a sixth pole of the sixth switch, wherein the fifth pole and the sixth pole are isolated from the capacitor when the third circuit is in a zero state.

10. The power converter of claim 7, wherein, for each module of the plurality of modules, a second switch throw of the first switch is directly coupled to a second switch throw of the second switch, and the circuit is in the zero state when the first pole contacts the second switch throw of the first switch and the second pole contacts the second switch throw of the second switch.

11. The power converter of claim 7, wherein a first module of the plurality of modules is coupled to a direct current voltage, and wherein a last module of the plurality of modules in series outputs a converted alternating current voltage.

12. The power converter of claim 7, wherein a first alternating current is input to a first module of the plurality of modules, and wherein a last module of the plurality of modules in series outputs a converted alternating current.

13. The power converter of claim 7, wherein a single phase of a three-phase alternating current voltage is input to the first module of the plurality of modules, and wherein a last module of the plurality of modules in series outputs a converted three-phase alternating current voltage.

14. The power converter of claim 7, wherein each module of the plurality of modules comprises a half-bridge module or a full-bridge module.

15. A power converter, comprising:
a plurality of modules configured in series, wherein each module comprises:
a capacitor; and
a circuit comprising a plurality of switches coupled to the capacitor, wherein a pole voltage is fully differential between a first pole and a second pole, and
wherein the first pole and the second pole are isolated from the capacitor when the circuit is in a zero state.

16. The power converter of claim 15, wherein the plurality of switches comprise single-pole double-throw semiconductor switches or single-pole triple-throw semiconductor switches.

17. The power converter of claim 15, wherein the plurality of switches comprise IGBTs, HEMTs, IGCTs, or MOSFET devices.

18. The power converter of claim 15, wherein the plurality of modules are configured to convert a direct current voltage to a three-phase alternating current voltage.

19. The power converter of claim 15, wherein the plurality of modules are configured to convert a first three-phase alternating current voltage to a second three-phase alternating current voltage.

20. The power converter of claim 15, wherein the plurality of modules are configured to convert a first three-phase alternating current voltage to a direct current voltage, and to convert the direct current voltage to a second three-phase alternating current voltage.
